(19) United States
(12) Patent Application Publication
(10) Pub. No.: US 2008/0092397 A1
(43) Pub. Date: Apr. 24, 2008

(54) MULTI-FUNCTIONAL ENGINEERING CLIPPER

(76) Inventor: Chih-Ching HSIEH, Taichung Hsien (TW)

Correspondence Address: Chih-Ching HSIEH, 235 Chung - Ho Box 8-24 Taipei, Taiwan, R. O. C., Taichung Hsien, 235, TW

(21) Appl. No.: 11/962,121

(22) Filed: Dec. 21, 2007

Related U.S. Application Data
(63) Continuation-in-part of application No. 10/795,832, filed on Mar. 9, 2004, now abandoned.

(51) Int. Cl. B26B 13/22

(52) U.S. Cl. 30/254

(57) ABSTRACT

A multi-functional engineering clipper comprises a cutting portion and a handle portion; a plurality of screwing units for fixing the cutting portion with the handle portion; two pivotal portions being installed on the cutting portion; a front end of each pivotal portion being installed with a first knife portion; each first knife portion having a flat knife; the two flat knives being symmetrically arranged; a rear end of each pivotal portion being installed with a second knife portion; each second knife portion having a semi-round knife; the two semi-round knives being symmetrically arranged; and a rear end of each second knife portion being extended with a third knife portion; each third knife portion having a cambered knife. Thus, the multi-functional engineering clipper can be used to cut steel plates, steel strips, nails, rivets, cables, iron strips, cables, etc.

The present invention is a continuation in part (CIP) of U.S. patent application Ser. No. 10/795,832. The contents of the U.S. patent application Ser. No. 10/795,832. are incorporated into the present invention as a part of the present invention.

### FIELD OF THE INVENTION

The present invention relates to clippers, and particular to a multi-functional engineering clipper which is especially used to cut steel plates, steel cables, and cables.

### BACKGSEMI-ROUND OF THE INVENTION

There are various kinds of multi-functional engineering clippers in the prior art. In one prior art, such as that disclosed in U.S. Pat. No. 5,974,670, “Milti-purpose Tool”, a multi-functional engineering clipper has a front cutting portion and a rear handle portion. The cutting portion has two pivotal shafts. A front end of each pivotal shaft has a knife end for cutting steel cables or iron cables. The rear end of each pivotal shaft is installed with a first knife portion and a second knife portion for cutting cables, nails or rivets. However, this prior art clipper cannot be used to cut iron plates or iron strips which frequently occur in engineering. Thereby, it is often that the user must prepare another one

Although the second knife portion can be used to cut iron plates and iron strips, the cutting operation is inconvenient because the areas of iron plates are too large and the knives are faced inwards. It is very possible that that the iron plate is placed out of the second knife portion so that the iron plate must be relocated. This is unbeneficial from the viewpoint of ergonomics.

### SUMMARY OF THE INVENTION

Accordingly, the primary object of the present invention is to provide a multi-functional engineering clipper which is used to cut steel plates, steel strips, nails, rivets, cables, iron strips, cables, etc.

To achieve above object, the present invention provides a multi-functional engineering clipper. The clipper comprises: a cutting portion and a handle portion; a plurality of screwing units for fixing the cutting portion with the handle portion; two pivotal portions being installed on the cutting portion; a front end of each pivotal portion being installed with a first knife portion; each first knife portion having a flat knife; the two flat knives being symmetrically arranged; a rear end of each pivotal portion being installed with a second knife portion; each second knife portion having a semi-round knife; the two semi-round knives being symmetrically arranged; and a rear end of each second knife portion being extended with a third knife portion; each third knife portion having a cambered knife.

The various objects and advantages of the present invention will be more readily understood from the following detailed description when read in conjunction with the appended drawing.

### BRIEF DESCRIPTION OF THE DRAWINGS

FIG. 1 is an exploded perspective view of the multi-functional engineering clipper of the present invention.

FIG. 2 is a perspective view about the multi-functional engineering clipper of the present invention.

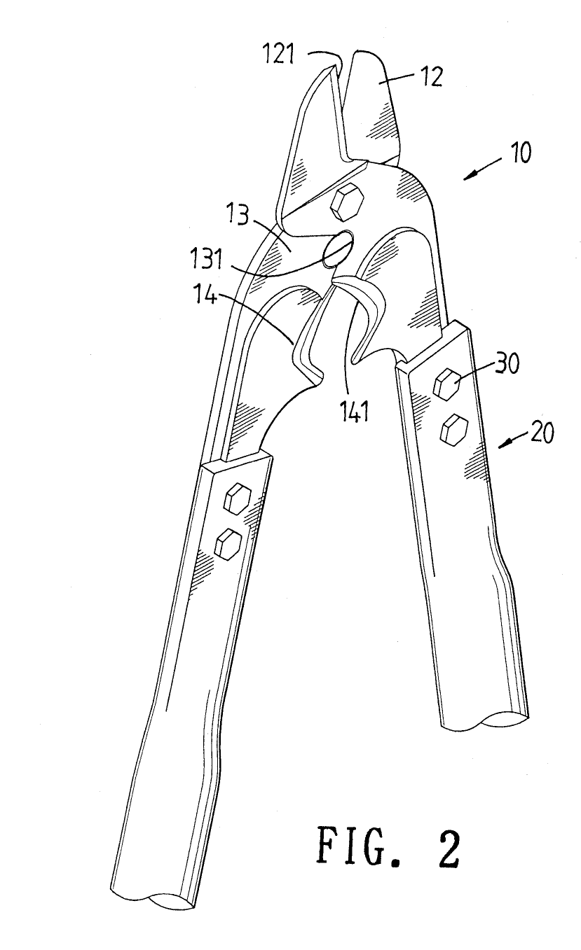

FIG. 3 is an assemble view of the multi-functional engineering clipper of the present invention.

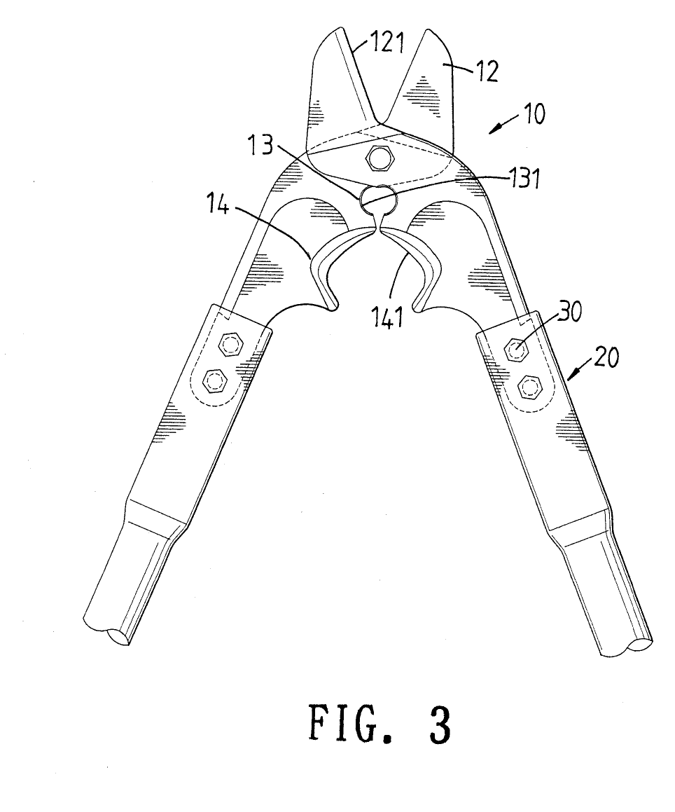

FIG. 4 shows a first application of the multi-functional engineering clipper of the present invention.

FIG. 5 is a second application of the multi-functional engineering clipper of the present invention.

FIG. 6 is a third application of the multi-functional engineering clipper of the present invention.

FIG. 7 shows the operation of the multi-functional engineering clipper of the present invention.

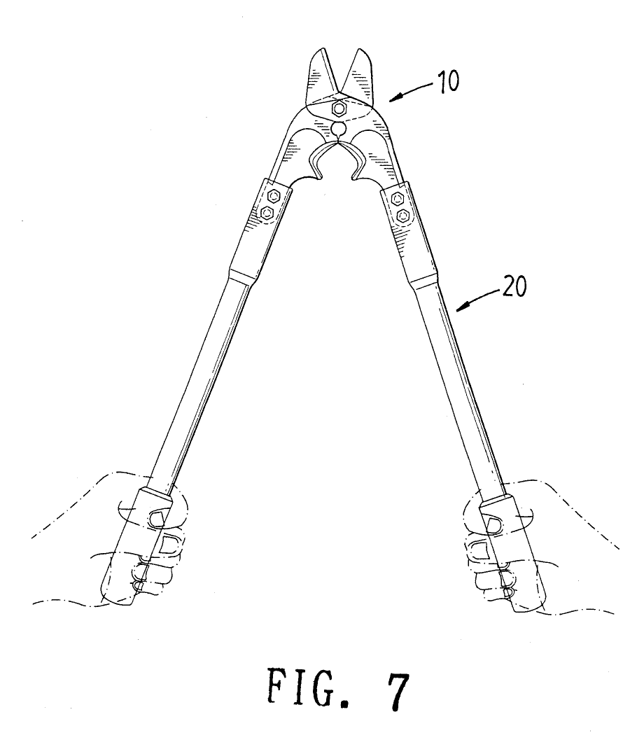

FIG. 8 is another operation of the multi-functional engineering clipper of the present invention.

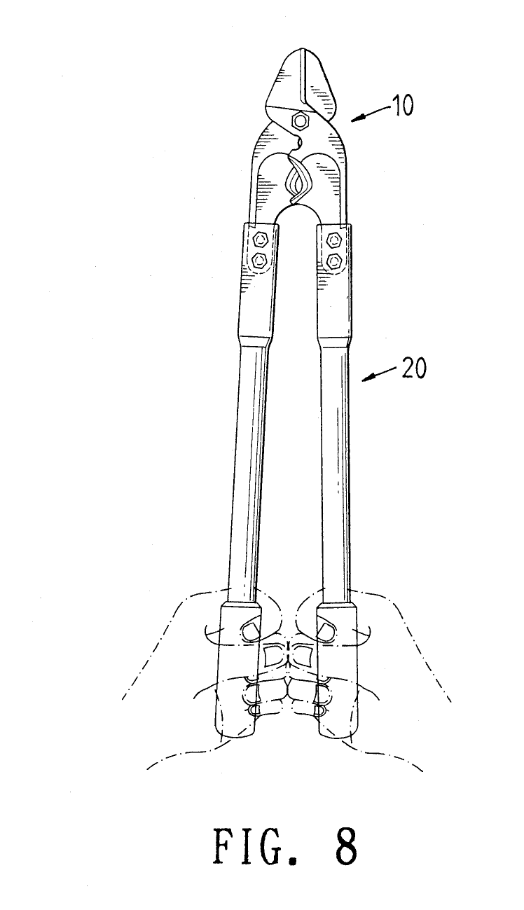

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

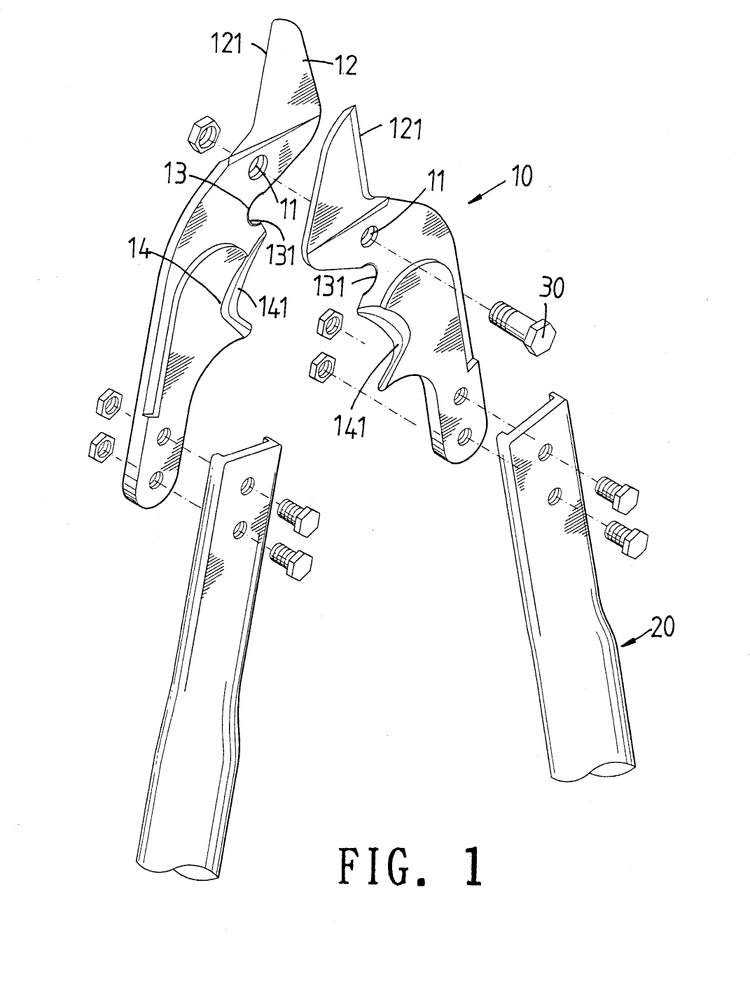

Referring to FIG. 1, the multi-functional engineering clipper of the present invention is illustrated. The multi-functional engineering clipper includes a cutting portion 10 and a handle portion 20. A plurality of screwing units 30 serve to fix the cutting portion 10 with the handle portion 20. The cutting portion 10 has two pivotal portions 11. A front end of each pivotal portion 11 is installed with a first knife portion 1. Each first knife portion 12 has a flat knife 121. The two flat knives 121 are symmetrically arranged for cutting hard metals, such as steel plates, steel strips or iron nails.

A rear end of each pivotal portion 11 is installed with a second knife portion 13. Each second knife portion 13 has a semi-round knife 131. The two semi-round knives 131 are symmetrically arranged. Each semi-round knife 131 is used for piercing cables.

Meanwhile, a rear end of each second knife portion 13 is extended with a third knife portion 14. Each third knife portion 14 has a cambered knife 141 for cutting iron ropes, or iron cables, etc.

It should be noted that the handle portion 20 is formed by two handles; each handle has an approximately U shape recess for receiving a respective one of the legs of the cutting portion 10; two lateral sides of each handle are approximately parallel and two lateral sides of each leg are approximately parallel.

Each handle is locked to the respective leg by using two screws to pass through the handle and the leg from the lateral sides of the handle and the leg; wherein a lower portion of the cutting portion is thicker than an upper portion of the cutting portion;

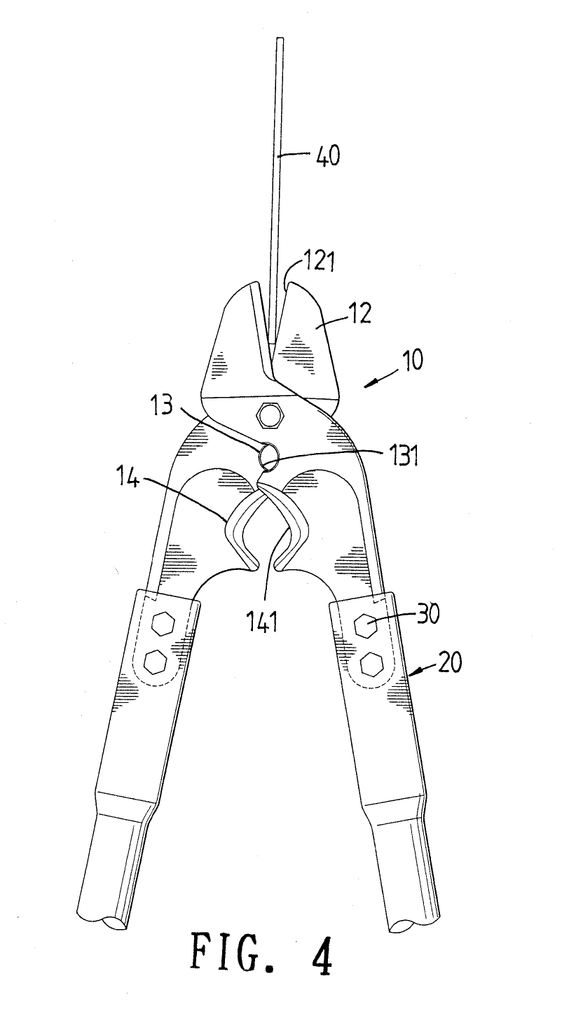

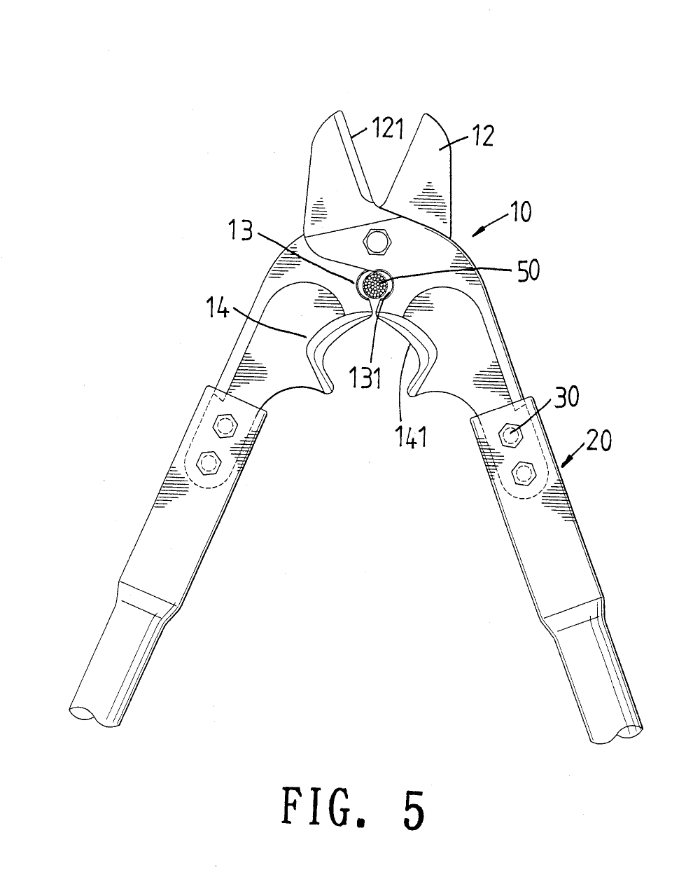

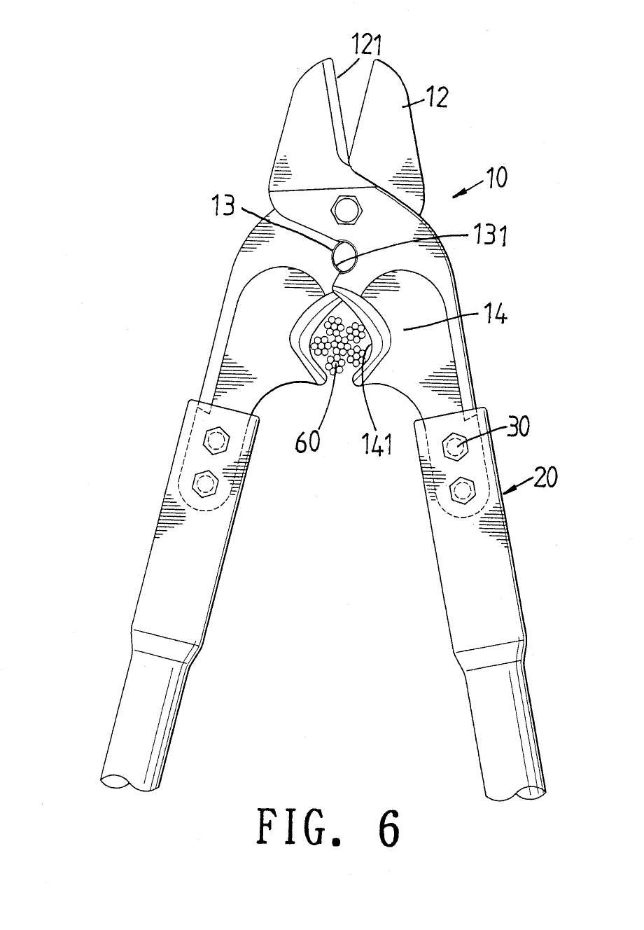

In use, with reference to FIGS. 4 to 6, when cutting a steel plate 40, the steel plate is placed on the first knife portion 12 (referring to FIG. 4), the flat knives serve to cut the steel plate 40 to a desired size. The first knife portion 12 is an independent opening. When the first knife portion is not used, the steel plate 40 will move to other knives. When cutting cable 50, see FIG. 5, the cable 50 is placed on the semi-round knife 131 of the second knife portion 13. When the two semi-round knives 131 are combined, a round knife is formed for cutting the periphery of the cable 50 but the core of the cable 50 will not be cut. When an iron rope 60 is cut, the iron rope 60 is placed in the third knife portion 14, the cambered knives 141 serve to cut the iron rope 60 so as to get a required size.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A multi-functional engineering clipper comprising: a cutting portion and a handle portion; a plurality of screwing units for fixing the cutting portion with the handle portion; two pivotal portions being installed on the cutting portion;
a front end of each pivotal portion being installed with a first knife portion; each first knife portion having a flat knife; the two flat knives being symmetrically arranged;
a rear end of each pivotal portion being installed with a second knife portion; each second knife portion having a semi-round knife; the two semi-round knives being symmetrically arranged; and
a rear end of each second knife portion being extended with a third knife portion; each third knife portion having a cambered knife.

2. The multi-functional engineering clipper as claimed in claim 1, wherein the first knife portion serves for cutting one of steel plates and steel strips.

3. The multi-functional engineering clipper as claimed in claim 1, wherein the second knife portion serves for cutting cables.

4. The multi-functional engineering clipper as claimed in claim 1, wherein the third knife portion serves for cutting one of steel ropes and steel ropes.

5. A multi-functional engineering clipper comprising: a cutting portion and a handle portion; the cutting portion having two pivotal portions;
a front end of each pivotal portion being installed with two first knife portions; each first knife portion having a flat knife; the two flat knives being symmetrically arranged;
a rear end of each first knife portion being extended with a second knife portion; each second knife portion having a semi-round knife; the two semi-round knives being symmetrically arranged; and
a rear end of each second knife portion being extended with a third knife portion; each third knife portion having a cambered knife;
a rear end of each third knife portion being extended with a leg;
wherein the handle portion is formed by two handles; each handle has an approximately U shape recess for receiving a respective one of the legs of the cutting portion; two lateral sides of each handle are approximately parallel and two lateral sides of each leg are approximately parallel;
each handle being locked to the respective leg by using screws to pass through the handle and the leg from the lateral sides of the handle and the leg;
wherein the first knife portion serves for cutting one of steel plates and steel strips;
wherein the second knife portion serves for cutting cables; and
wherein the third knife portion serves for cutting steel ropes.

6. The multi-functional engineering clipper as claimed in claim 5, wherein a lower portion of the cutting portion is thicker than an upper portion of the cutting portion so as to provide a firm structure at the connection of the cutting portions and the handle portion.
